(19) United States
(12) Patent Application Publication
(10) Pub. No.: US 2022/0222582 A1
(43) Pub. Date: Jul. 14, 2022

(54) GENERATION METHOD, COMPUTER-READABLE RECORDING MEDIUM STORING GENERATION PROGRAM, AND INFORMATION PROCESSING APPARATUS

(71) Applicant: FUJITSU LIMITED, Kawasaki-shi (JP)

(72) Inventor: Yasuto Yokota, Kawasaki (JP)

(73) Assignee: FUJITSU LIMITED, Kawasaki-shi (JP)

(21) Appl. No.: 17/708,126

(22) Filed: Mar. 30, 2022

Related U.S. Application Data
(63) Continuation of application No. PCT/JP2019/041804, filed on Oct. 24, 2019.

(51) Int. Cl. G06N 20/00; G06K 9/62

(52) U.S. Cl. CPC G06N 20/00; G06K 9/6265

(57) ABSTRACT

A computer-implemented generation method of generating a detection model, the generation method including: acquiring training data that has been used in training of a trained model; training the detection model on the basis of the acquired training data, the detection model being configured to detect accuracy deterioration occurred in the trained model by a change in a trend of data to be processed in a data stream; determining, for the trained detection model, a state of over-training; acquiring a feature amount of the trained detection model when the determined state of over-training satisfies a given condition; and generating the detection model on the basis of the acquired feature amount.

### CROSS-REFERENCE TO RELATED APPLICATION

This application is a continuation application of International Application PCT/JP2019/041804 filed on Oct. 24, 2019 and designated the U.S., the entire contents of which are incorporated herein by reference.

### FIELD

The embodiments discussed herein are related to a generation method, a generation program, and an information processing apparatus.

### BACKGROUND

For information systems used in companies and the like, introduction of machine learning models (hereinafter, may be simply referred to as “models”) for functions of determination and classification of data, and the like is in progress. Since the machine learning model performs the determination and the classification according to teacher data learned at the time of system development, when a trend (data distribution) of input data changes during system operation, accuracy of the machine learning model deteriorates.

Commonly, detection of accuracy deterioration of a model during system operation uses a method in which a correct answer rate is calculated by periodically and manually confirming correctness of an output result of the model by a human, and accuracy deterioration is detected from decrease in the correct answer rate.

In recent years, a T² statistic (Hotelling's T-square) is known as a technology for automatically detecting accuracy deterioration of a machine learning model during system operation. For example, principal component analysis is performed on input data and a normal data (training data) group, and a T² statistic of the input data, which is the sum of squares of distances from the origin of each standardized principal component, is calculated. Then, on the basis of a distribution of the T² statistic of the input data group, change in a percentage of abnormal value data is detected, and accuracy deterioration of the model is automatically detected.

Examples of the related art include as follows: A. Shabbak and H. Midi, “An Improvement of the Hotelling T² Statistic in Monitoring Multivariate Quality Characteristics”, Mathematical Problems in Engineering (2012) 1-15.

### SUMMARY

According to an aspect of the embodiments, there is provided a computer-implemented generation method of generating a detection model. In an example, the generation method includes: acquiring training data that has been used in training of a trained model; training the detection model on the basis of the acquired training data, the detection model being configured to detect accuracy deterioration occurred in the trained model by a change in a trend of data to be processed in a data stream; acquiring a feature amount of the trained detection model when the determined state of over-training satisfies a given condition; and generating the detection model on the basis of the acquired feature amount

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for describing an accuracy deterioration detection apparatus according to a first embodiment;

FIG. 2 is a diagram for describing accuracy deterioration;

FIG. 3 is a diagram for describing an inspector model according to the first embodiment;

FIG. 4 is a functional block diagram illustrating a functional configuration of the accuracy deterioration detection apparatus according to the first embodiment;

FIG. 5 is a diagram illustrating an example of information stored in a teacher data database (DB);

FIG. 6 is a diagram illustrating an example of information stored in an input data DB;

FIG. 7 is a diagram illustrating a relationship between the number of pieces of training data and an application range;

FIG. 8 is a diagram for describing detection of the accuracy deterioration;

FIG. 9 is a diagram for describing distribution change of a matching rate;

FIG. 10 is a flowchart illustrating a flow of processing;

FIG. 11 is a diagram for describing a comparison result of detection of accuracy deterioration of high-dimensional data;

FIG. 12 is a diagram for describing a comparison result of detection of accuracy deterioration of multi-class classification;

FIG. 13 is a diagram for describing a specific example using an image classifier;

FIG. 14 is a diagram for describing a specific example of teacher data;

FIG. 15 is a diagram for describing an execution result of detection of accuracy deterioration;

FIG. 16 is a diagram for describing an example of controlling a model applicability domain;

FIG. 17 is a diagram for describing an example of generating an inspector model according to a second embodiment;

FIG. 18 is a diagram for describing change in validation accuracy;

FIG. 19 is a diagram for describing generation of the inspector model by using the validation accuracy;

FIG. 20 is a diagram for describing an example in which boundary positions of a machine learning model and the inspector model do not change;

FIG. 21 is a diagram for describing an inspector model according to a third embodiment;

FIG. 22 is a diagram for describing detection of deterioration according to the third embodiment;

FIG. 23 is a diagram for describing an example of teacher data in an unknown class (class 10);

FIG. 24 is a diagram for describing an effect of the third embodiment; and

FIG. 25 is a diagram for describing a hardware configuration example.

### DESCRIPTION OF EMBODIMENTS

However, in the technology described above, there are many restrictions on the machine learning model for which accuracy deterioration is to be detected, and it is difficult to use the technology for general purposes.

For example, in a case where the technology described above is applied to a model that processes high-dimensional data of thousands to tens of thousands of dimensions with a very large amount of the original information, most of the information is lost when the dimensions are reduced to several dimensions by principal component analysis. Thus, even a feature amount, which is important information for classification and determination, is lost, it is not possible to detect abnormal data well, and it is not possible to implement detection of accuracy deterioration of the model.

Furthermore, since a distance of a principal component to the training data group is used for measurement in the T² statistic, in a case where data groups in a plurality of categories (multiple classes) are mixed in the training data, a range to be determined as normal data becomes wide. Thus, it is not possible to detect abnormal data, and it is not possible to implement detection of accuracy deterioration of the model.

In one aspect, it is an object to provide a generation method, a generation program, and an information processing apparatus capable of detecting accuracy deterioration also for a machine learning model that executes classification of high-dimensional data or multi-class classification.

Hereinafter, embodiments of a generation method, a generation program, and an information processing apparatus according to the present disclosure will be described in detail with reference to the drawings. Note that the embodiments do not limit the present disclosure. Furthermore, each of the embodiments may be appropriately combined within a range without inconsistency.

### First Embodiment

[Description of Accuracy Deterioration Detection Apparatus]

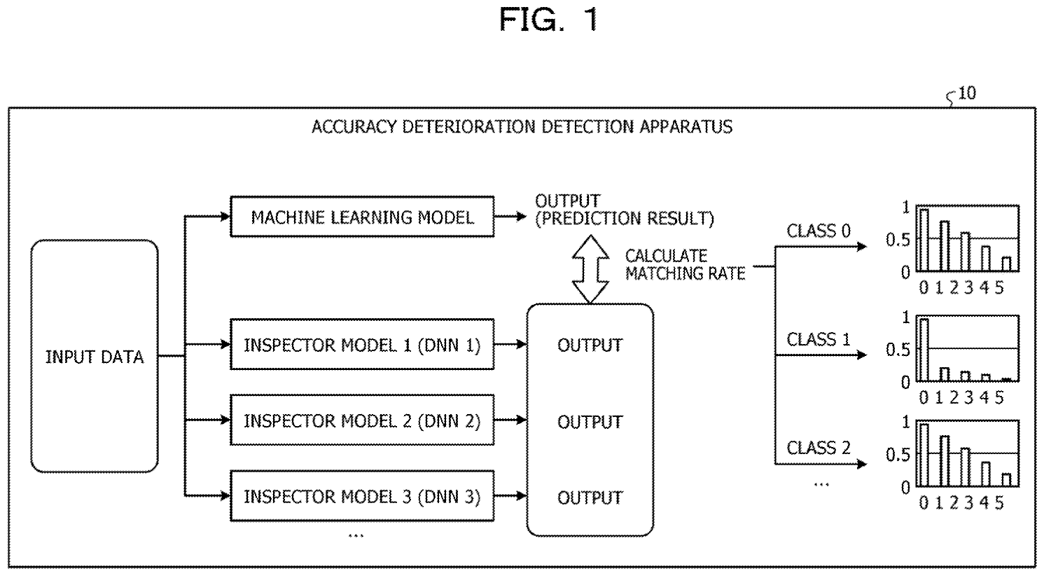

FIG. 1 is a diagram for describing an accuracy deterioration detection apparatus 10 according to a first embodiment. While the accuracy deterioration detection apparatus 10 illustrated in FIG. 1 executes determination (classification) of input data by using a trained machine learning model (hereinafter, may be simply referred to as a “model”), the accuracy deterioration detection apparatus 10 is an example of a computer device that monitors accuracy of the machine learning model and detects accuracy deterioration.

For example, the machine learning model is an image classifier that is trained by using teacher data using image data as an explanatory variable and a clothing name as an objective variable at the time of learning, and outputs a determination result such as “shirt” when image data is input as input data at the time of operation. For example, the machine learning model is an example of an image classifier that executes classification of high-dimensional data and multi-class classification. Note that learning of the machine learning model may also be referred to as training of the machine learning model. For example, in learning processing of the machine learning model, the machine learning model is trained by using teacher data and the like.

Here, since the machine learning model trained by machine learning, deep learning, or the like is trained on the basis of teacher data in which training data and labeling are combined, the machine learning model functions only within a range included in the teacher data. On the other hand, although the machine learning model is assumed to receive an input of the same kind of data as data at the time of learning after operation, in reality, a state of the data to be input may change and the machine learning model may not function properly. For example, “accuracy deterioration of the model” occurs.

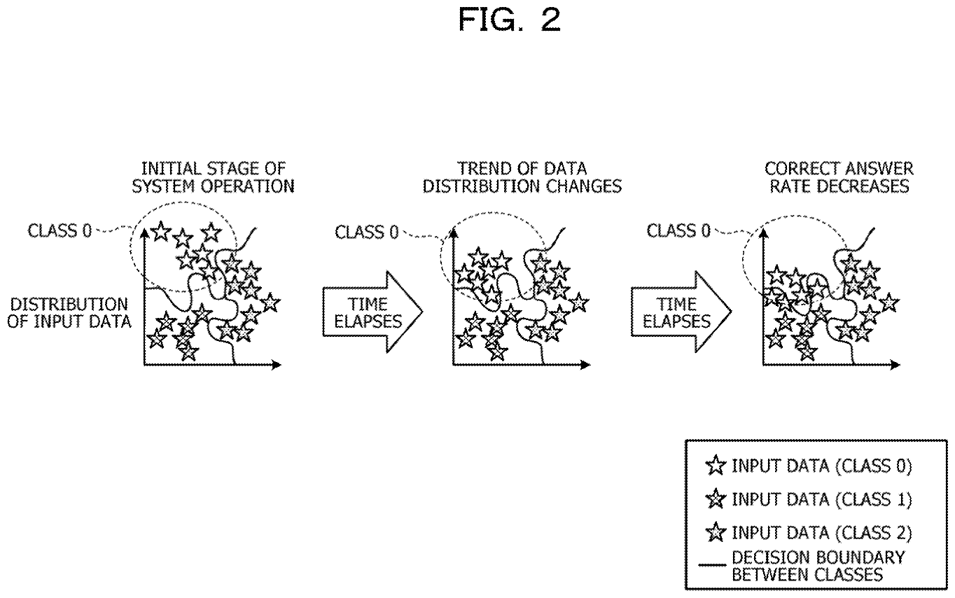

FIG. 2 is a diagram for describing accuracy deterioration. FIG. 2 illustrates a feature amount space which is information organized by excluding unnecessary data of input data and in which the machine learning model classifies the input data which has been input. FIG. 2 illustrates the feature amount space classified into a class 0, a class 1, and a class 2.

As illustrated in FIG. 2, at an initial stage of system operation (when learning is completed), all pieces of the input data are in normal positions and are classified inside a decision boundary of each class. As time elapses thereafter, a distribution of the input data of the class 0 changes. For example, input data that is difficult to be classified as the class 0 with a learned feature amount of the class 0 begins to be input. Moreover, thereafter, the input data of the class 0 crosses the decision boundary, and a correct answer rate of the machine learning model decreases. For example, the feature amount of the input data that should be classified as the class 0 changes.

In this way, when the distribution of the input data changes from that at the time of learning after the start of the system operation, as a result, the correct answer rate of the machine learning model decreases, and accuracy deterioration of the machine learning model occurs.

Thus, as illustrated in FIG. 1, the accuracy deterioration detection apparatus 10 according to the first embodiment uses at least one inspector model (monitor, hereinafter, may be simply referred to as “inspector”) generated by using a deep neural network (DNN), which solves a problem similar to that of the machine learning model to be monitored. For example, by totaling a matching rate between an output of the machine learning model and an output of each inspector model for each output class of the machine learning model, the accuracy deterioration detection apparatus 10 detects distribution change of the matching rate, which is, distribution change of the input data.

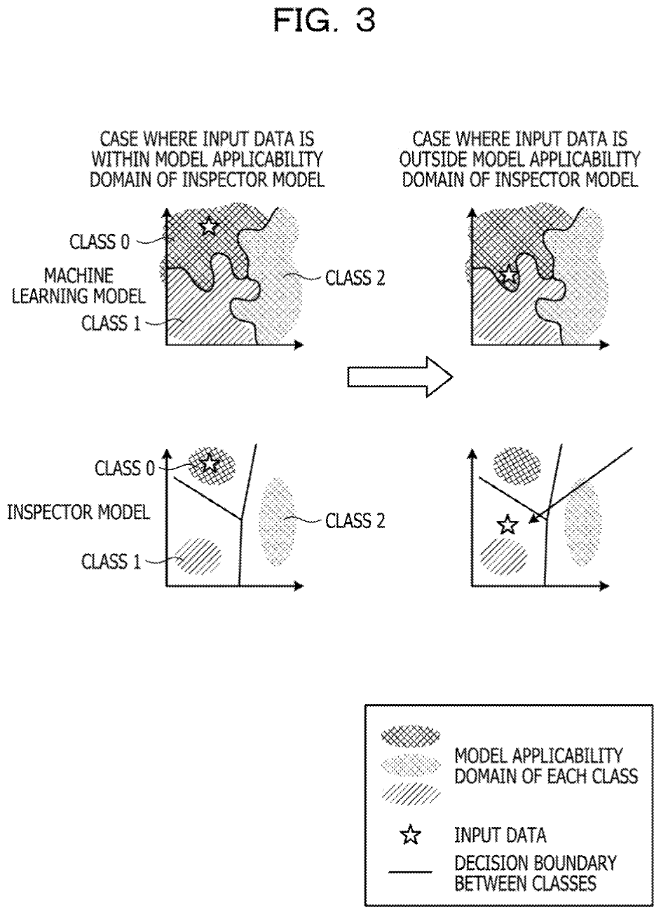

Here, the inspector model will be described. FIG. 3 is a diagram for describing the inspector model according to the first embodiment. The inspector model is an example of a detection model generated under a different condition (different model applicability domain) from the machine learning model. For example, the inspector model is generated so that a range of each domain (each feature amount) determined by the inspector model as the class 0, the class 1, and the class 2 is narrower than a range of each domain determined by the machine learning model as the class 0, the class 1, and the class 2.

This is because the narrower the model applicability domain, the more sensitively an output changes with small change in input data. Thus, by narrowing the model applicability domain of the inspector model compared to that of the machine learning model to be monitored, an output value of the inspector model fluctuates with small change in the input data, and change in a trend of the data may be measured by a matching rate with an output value of the machine learning model.

For example, as illustrated in FIG. 3, in a case where the input data is within the range of the model applicability domain of the inspector model, the machine learning model determines that the corresponding input data is in the class 0, and the inspector model also determines that the corresponding input data is in the class 0. For example, both are within the model applicability domain of the class 0, and the output values always match, so the matching rate does not decrease.

On the other hand, in a case where the input data is outside the range of the model applicability domain of the inspector model, the machine learning model determines that the corresponding input data is in the class 0, but the inspector model does not always determine that the corresponding input data is in the class 0 because the corresponding input data is in a domain outside the model application range of each class. For example, since the output values do not always match, the matching rate decreases.

In this way, the accuracy deterioration detection apparatus 10 according to the first embodiment executes class determination by the inspector model trained to have the model applicability domain narrower than the model applicability domain of the machine learning model in parallel with class determination by the machine learning model, and calculates a matching rate of both the class determination. Then, since the accuracy deterioration detection apparatus 10 detects distribution change of the input data by change in the matching rate, it is possible to detect accuracy deterioration of the machine learning model that executes classification of high-dimensional data and multi-class classification.

[Functional Configuration of Accuracy Deterioration Detection Apparatus]

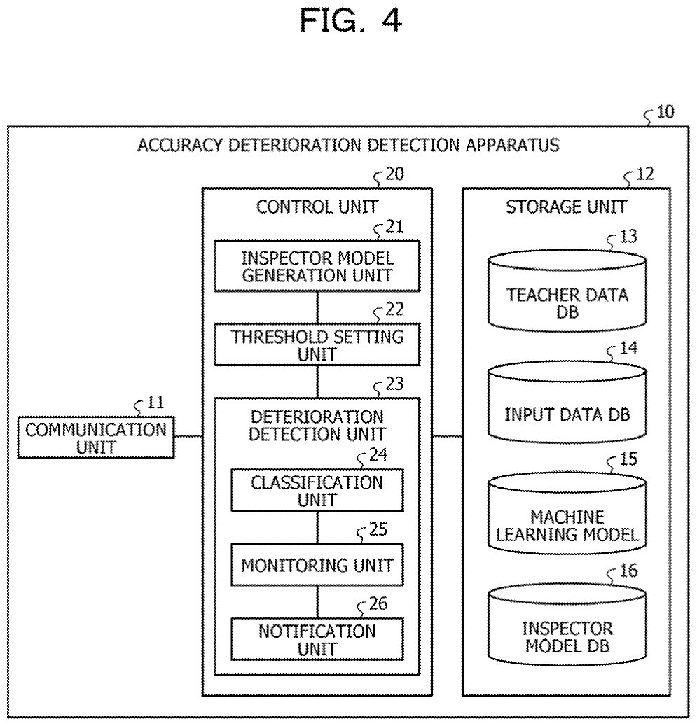

FIG. 4 is a functional block diagram illustrating a functional configuration of the accuracy deterioration detection apparatus 10 according to the first embodiment. As illustrated in FIG. 4, the accuracy deterioration detection apparatus 10 includes a communication unit 11, a storage unit 12, and a control unit 20.

The communication unit 11 is a processing unit that controls communication with another device, and is, for example, a communication interface. For example, the communication unit 11 receives various instructions from an administrator terminal or the like. Furthermore, the communication unit 11 receives input data to be determined from various terminals.

The storage unit 12 is an example of a storage device that stores data and a program or the like executed by the control unit 20, and is, for example, a memory or a hard disk. The storage unit 12 stores a teacher data database (DB) 13, an input data DB 14, a machine learning model 15, and an inspector model DB 16.

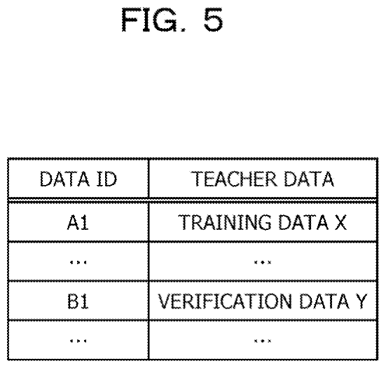

The teacher data DB 13 is a database that stores teacher data used for training of the machine learning model and also used for training of the inspector model. FIG. 5 is a diagram illustrating an example of information stored in the teacher data DB 13. As illustrated in FIG. 5, the teacher data DB 13 stores a data identification (ID) and teacher data in association with each other.

The data ID stored here is an identifier that identifies the teacher data. The teacher data is training data used for learning or verification data used for verification at the time of learning. In the example of FIG. 5, training data X whose data ID is “A1” and verification data Y whose data ID is “B1” are illustrated. Note that the training data and the verification data are data in which image data as an explanatory variable and correct answer information (label) as an objective variable are associated with each other.

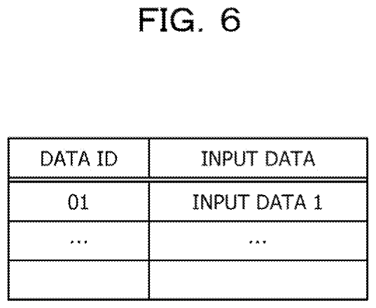

The input data DB 14 is a database that stores input data to be determined. For example, the input data DB 14 stores image data to be input to the machine learning model and to be subjected to image classification. FIG. 6 is a diagram illustrating an example of information stored in the input data DB 14. As illustrated in FIG. 6, the input data DB 14 stores a data ID and input data in association with each other.

The data ID stored here is an identifier that identifies the input data. The input data is image data to be classified. In the example of FIG. 6, input data 1 whose data ID is “01” is illustrated. The input data does not need to be stored in advance and may also be transmitted as a data stream from another terminal.

The machine learning model 15 is a trained machine learning model, and is a model to be monitored by the accuracy deterioration detection apparatus 10. Note that the machine learning model 15 such as a neural network or a support vector machine in which trained parameters are set may also be stored, and trained parameters or the like that may construct the trained machine learning model 15 may also be stored.

The inspector model DB 16 is a database that stores information regarding at least one inspector model used for detection of accuracy deterioration. For example, the inspector model DB 16 stores parameters for constructing each of five inspector models, which are various parameters of the DNN generated (optimized) by machine learning by the control unit 20 described later. Note that the inspector model DB 16 may also store trained parameters, and may also store the inspector model itself (DNN) in which trained parameters are set.

The control unit 20 is a processing unit that controls the entire accuracy deterioration detection apparatus 10, and is, for example, a processor. The control unit 20 includes an inspector model generation unit 21, a threshold setting unit 22, and a deterioration detection unit 23. Note that the inspector model generation unit 21, the threshold setting unit 22, and the deterioration detection unit 23 are examples of electronic circuits included in a processor, examples of processes executed by a processor, and the like.

The inspector model generation unit 21 is a processing unit that generates an inspector model, which is an example of a monitor or a detection model that detects accuracy deterioration of the machine learning model 15. For example, the inspector model generation unit 21 generates a plurality of inspector models having different model application ranges by deep learning using teacher data used for training of the machine learning model 15. Then, the inspector model generation unit 21 stores, in the inspector model DB 16, various parameters for constructing each of the inspector models (each of the DNNs) that have different model application ranges and are obtained by the deep learning.

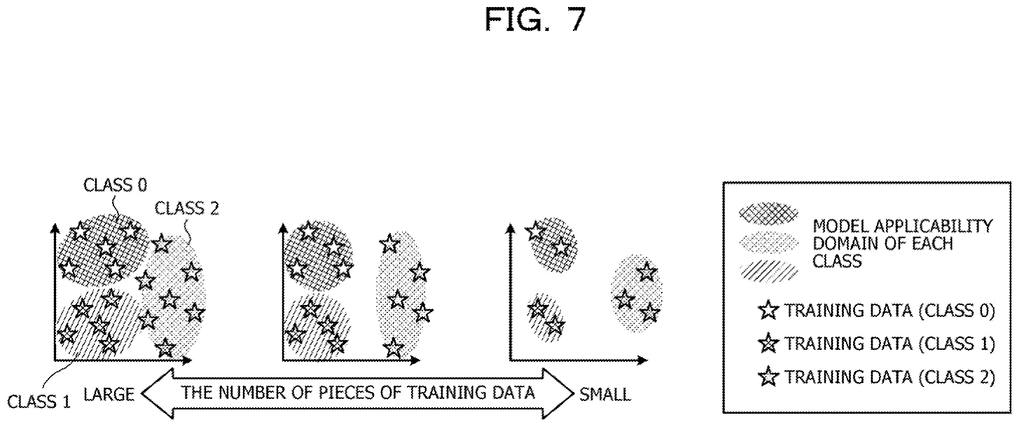

For example, the inspector model generation unit 21 generates the plurality of inspector models having different application ranges by controlling the number of pieces of training data. FIG. 7 is a diagram illustrating a relationship between the number of pieces of training data and an application range. FIG. 7 illustrates a feature amount space classified into three classes of the class 0, the class 1, and the class 2.

As illustrated in FIG. 7, commonly, as the number of pieces of training data increases, more feature amounts are learned, so that more comprehensive learning is executed, and a model having a wider model application range is generated. On the other hand, as the number of pieces of training data decreases, a feature amount of teacher data to be learned is smaller, so that a range (feature amount) that may be covered is limited, and a model having a narrower model application range is generated.

Thus, the inspector model generation unit 21 generates the plurality of inspector models by changing the number of pieces of training data while keeping the number of times of training the same. For example, a case is considered where the five inspector models are generated in a state where the machine learning model 15 is trained by the number of times of training (100 epochs) and the number of pieces of training data (1000 pieces/class). In this case, the inspector model generation unit 21 decides the number of pieces of training data of an inspector model 1 as “500 pieces/class”, the number of pieces of training data of an inspector model 2 as “400 pieces/class”, the number of pieces of training data of an inspector model 3 as “300 pieces/class”, the number of pieces of training data of an inspector model 4 as “200 pieces/class”, and the number of pieces of training data of an inspector model 5 as “100 pieces/class”, selects teacher data at random from the teacher data DB 13, and trains each by 100 epochs.

Thereafter, the inspector model generation unit 21 stores, in the inspector model DB 16, various parameters of each of the trained inspector models 1, 2, 3, 4, and 5. In this way, the inspector model generation unit 21 may generate the five inspector models having the model application ranges narrower than the application range of the machine learning model 15 and each having the different model application range.

Note that the inspector model generation unit 21 may train each inspector model by using a method such as error back propagation, and may also adopt another method. For example, the inspector model generation unit 21 executes training of the inspector models (DNN) by updating parameters of the DNN so that an error between an output result obtained by inputting training data into the inspector model and a label of the input training data becomes small.

Returning to FIG. 4, the threshold setting unit 22 sets a threshold that determines accuracy deterioration of the machine learning model 15 and is used for determination of a matching rate. For example, the threshold setting unit 22 reads the machine learning model 15 from the storage unit 12 and reads various parameters from the inspector model DB 16 to construct the five trained inspector models. Then, the threshold setting unit 22 reads each piece of verification data stored in the teacher data DB 13, inputs the read verification data to the machine learning model 15 and each inspector model, and acquires a distribution result to the model applicability domain based on each output result (classification result).

Thereafter, the threshold setting unit 22 calculates a matching rate of each class between the machine learning model 15 and the inspector model 1, a matching rate of each class between the machine learning model 15 and the inspector model 2, a matching rate of each class between the machine learning model 15 and the inspector model 3, a matching rate of each class between the machine learning model 15 and the inspector model 4, and a matching rate of each class between the machine learning model 15 and the inspector model 5, for the verification data.

Then, the threshold setting unit 22 sets a threshold by using each matching rate. For example, the threshold setting unit 22 displays each matching rate on a display or the like, and accepts setting of the threshold from a user. Furthermore, the threshold setting unit 22 may optionally select and set, according to a deterioration state, detection of which is requested by the user, an average value of each matching rate, the maximum value of each matching rate, the minimum value of each matching rate, and the like.

Returning to FIG. 4, the deterioration detection unit 23 is a processing unit that includes a classification unit 24, a monitoring unit 25, and a notification unit 26, compares an output result of the machine learning model 15 and an output result of each inspector model for input data, and detects accuracy deterioration of the machine learning model 15.

The classification unit 24 is a processing unit that inputs input data to each of the machine learning model 15 and each inspector model and acquires an output result (classification result) of each. For example, when training of each inspector model is completed, the classification unit 24 acquires parameters of each inspector model from the inspector model DB 16 to construct each inspector model, and executes the machine learning model 15.

Then, the classification unit 24 inputs input data to the machine learning model 15 and acquires an output result, and inputs the corresponding input data to each of the five inspector models from the inspector model 1 (DNN 1) to the inspector model 5 (DNN 5) and acquires each output result. Thereafter, the classification unit 24 stores the input data and each output result in the storage unit 12 in association with each other, and outputs the associated input data and each output result to the monitoring unit 25.

The monitoring unit 25 is a processing unit that monitors accuracy deterioration of the machine learning model 15 by using an output result of each inspector model. For example, the monitoring unit 25 measures, for each class, distribution change of a matching rate between an output of the machine learning model 15 and an output of the inspector model. For example, the monitoring unit 25 calculates a matching rate between an output result of the machine learning model 15 and an output result of each inspector model for each piece of input data, and in a case where the matching rate decreases, detects accuracy deterioration of the machine learning model 15. Note that the monitoring unit 25 outputs a detection result to the notification unit 26.

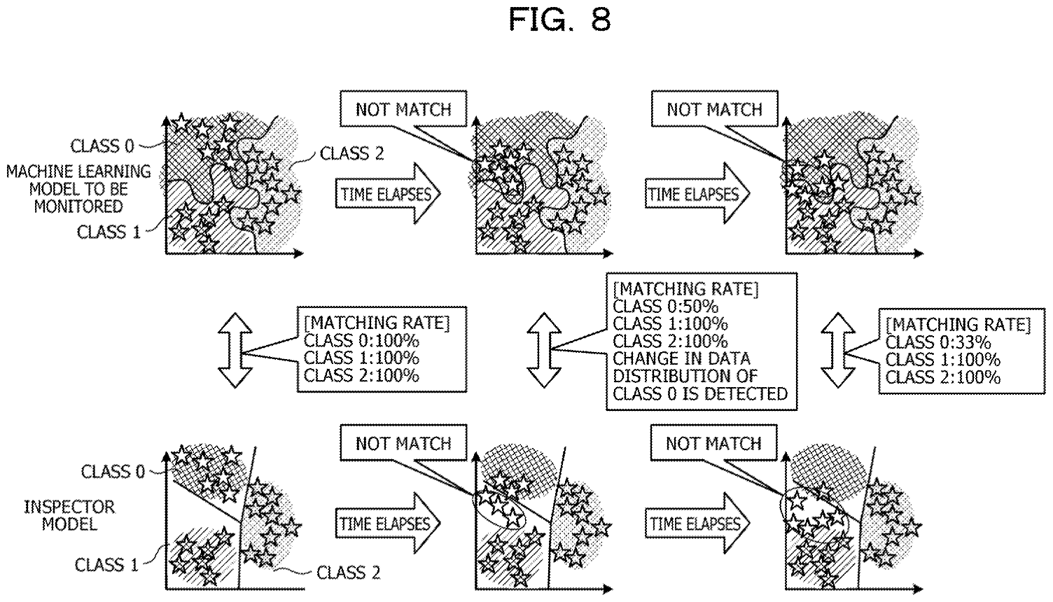

FIG. 8 is a diagram for describing detection of accuracy deterioration. FIG. 8 illustrates an output result of the machine learning model 15 to be monitored and an output result of the inspector model for input data. Here, for clarity of description, using one inspector model as an example, a probability that an output of the inspector model matches an output of the machine learning model 15 to be monitored will be described by using a data distribution to model applicability domains in a feature amount space.

As illustrated in FIG. 8, at the start of operation, the monitoring unit 25 acquires from the machine learning model 15 to be monitored that six pieces of input data belong to a model applicability domain of the class 0, six pieces of input data belong to a model applicability domain of the class 1, and eight pieces of input data belong to a model applicability domain of the class 2. On the other hand, the monitoring unit 25 acquires from the inspector model that six pieces of input data belong to a model applicability domain of the class 0, six pieces of input data belong to a model applicability domain of the class 1, and eight pieces of input data belong to a model applicability domain of the class 2.

For example, since a matching rate of each class between the machine learning model 15 and the inspector model matches, the monitoring unit 25 calculates the matching rate as 100%. At this timing, each classification result matches.

As time elapses, the monitoring unit 25 acquires from the machine learning model 15 to be monitored that six pieces of input data belong to the model applicability domain of the class 0, six pieces of input data belong to the model applicability domain of the class 1, and eight pieces of input data belong to the model applicability domain of the class 2. On the other hand, the monitoring unit 25 acquires from the inspector model that three pieces of input data belong to the model applicability domain of the class 0, six pieces of input data belong to the model applicability domain of the class 1, and eight pieces of input data belong to the model applicability domain of the class 2.

For example, the monitoring unit 25 calculates the matching rate as 50% (( 3/6)×100) for the class 0, and calculates the matching rate as 100% for the class 1 and the class 2. For example, change in a data distribution of the class 0 is detected. At this timing, in the inspector model, the three pieces of input data not classified as the class 0 are not always classified as the class 0.

As time elapses further, the monitoring unit 25 acquires from the machine learning model 15 to be monitored that three pieces of input data belong to the model applicability domain of the class 0, six pieces of input data belong to the model applicability domain of the class 1, and eight pieces of input data belong to the model applicability domain of the class 2. On the other hand, the monitoring unit 25 acquires from the inspector model that one piece of input data belongs to the model applicability domain of the class 0, six pieces of input data belong to the model applicability domain of the class 1, and eight pieces of input data belong to the model applicability domain of the class 2.

For example, the monitoring unit 25 calculates the matching rate as 33% ((⅓)×100) for the class 0, and calculates the matching rate as 100% for the class 1 and the class 2. For example, it is determined that the data distribution of the class 0 has changed. At this timing, in the machine learning model 15, the pieces of input data that should be classified as the class 0 are not classified as the class 0, and in the inspector model, the five pieces of input data not classified as the class 0 are not always classified as the class 0.

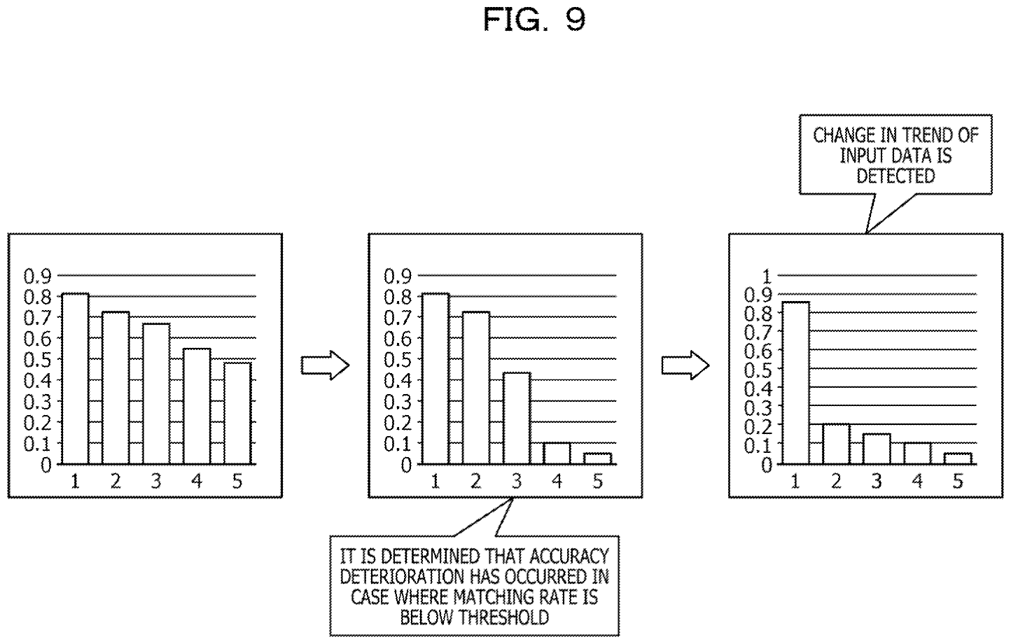

Here, change in a distribution of the matching rate will be described. FIG. 9 is a diagram for describing distribution change of the matching rate. In FIG. 9, a horizontal axis indicates each inspector model, and a vertical axis indicates the matching rate (matched percentage), and change in the matching rate between each of the five inspector models and the machine learning model 15 for a certain class is illustrated.

With respect to the size of the model applicability domains of the inspector models 1, 2, 3, 4, and 5, it is assumed that the inspector model 1 is the widest and the inspector model 5 is the narrowest. In this case, as time elapses from the initial stage of the start of the operation, the narrower the model applicability domain of the inspector model, the more sensitively the inspector model reacts to a distribution of data, so the matching rates of the inspector models 5 and 4 decrease. The monitoring unit 25 may detect occurrence of accuracy deterioration by detecting that the matching rates of the inspector models 5 and 4 are below a threshold. Furthermore, the monitoring unit 25 may detect change in a trend of input data by detecting that the matching rates of most of the inspector models are below the threshold.

Returning to FIG. 4, the notification unit 26 is a processing unit that notifies a predetermined device of an alert or the like in a case where accuracy deterioration of the machine learning model 15 is detected. For example, the notification unit 26 notifies an alert in a case where an inspector model having a matching rate lower than a threshold is detected, or in a case where a predetermined number or more of inspector models having matching rates lower than the threshold are detected.

Furthermore, the notification unit 26 may also notify an alert for each class. For example, the notification unit 26 notifies an alert in a case where a predetermined number or more of inspector models having matching rates lower than the threshold are detected for a certain class. Note that monitoring items may be optionally set for each class, each inspector model, or the like. Furthermore, for each inspector model, an average matching rate for each class may be used as a matching rate for each inspector model.

[Flow of Processing]

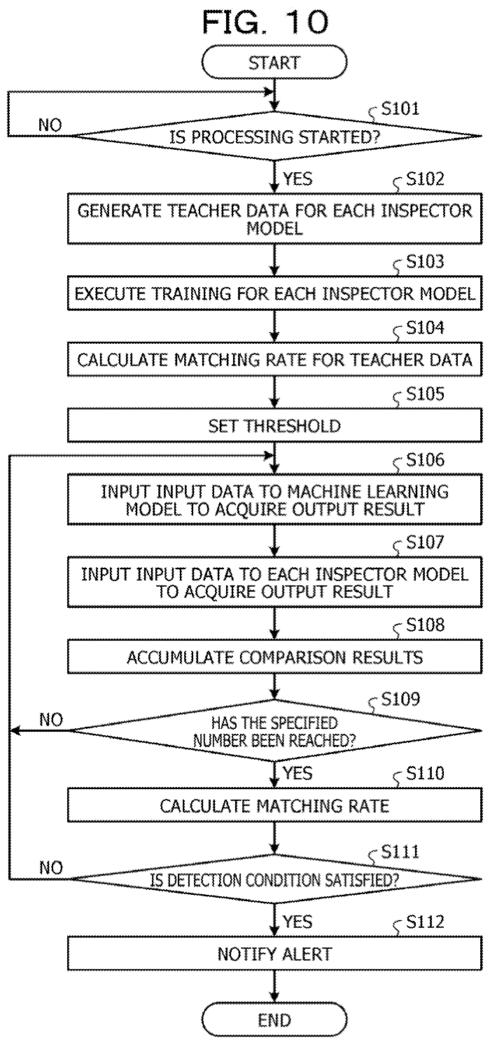

FIG. 10 is a flowchart illustrating a flow of processing. As illustrated in FIG. 10, when the processing is started (S101: Yes), the inspector model generation unit 21 generates teacher data for each inspector model (S102), and by using training data in the generated teacher data, executes training for each inspector model to generate each inspector model (S103).

Subsequently, the threshold setting unit 22 calculates a matching rate between output results obtained by inputting verification data in the teacher data to the machine learning model 15 and each inspector model (S104), and sets a threshold on the basis of the matching rate (S105).

Thereafter, the deterioration detection unit 23 inputs input data to the machine learning model 15 to acquire an output result (S106), and inputs the input data to each inspector model to acquire an output result (S107).

Then, the deterioration detection unit 23 accumulates comparison of the output results, which is, a distribution to a model applicability domain in a feature amount space (S108), and repeats S106 and subsequent steps until the accumulated number reaches the specified number (S109: No).

Thereafter, when the accumulated number reaches the specified number (S109: Yes), the deterioration detection unit 23 calculates a matching rate between each inspector model and the machine learning model 15 for each class (S110).

Here, in a case where the matching rate does not satisfy a detection condition (S111: No), S106 and subsequent steps are repeated, and in a case where the matching rate satisfies the detection condition (S111: Yes), the deterioration detection unit 23 notifies an alert (S112).

[Effects]

As described above, the accuracy deterioration detection apparatus 10 generates at least one or more inspector models in which the range of the model applicability domain is narrower than that of the machine learning model to be monitored. Then, the accuracy deterioration detection apparatus 10 measures, for each class, the distribution change of the matching rate between the output of the machine learning model and the output of each inspector model. As a result, the accuracy deterioration detection apparatus 10 may detect accuracy deterioration of the model even for a multi-class classification problem of high-dimensional data, and may detect functional deterioration of the trained model due to time change in the trend of the input data without using correctness information of the output of the machine learning model 15.

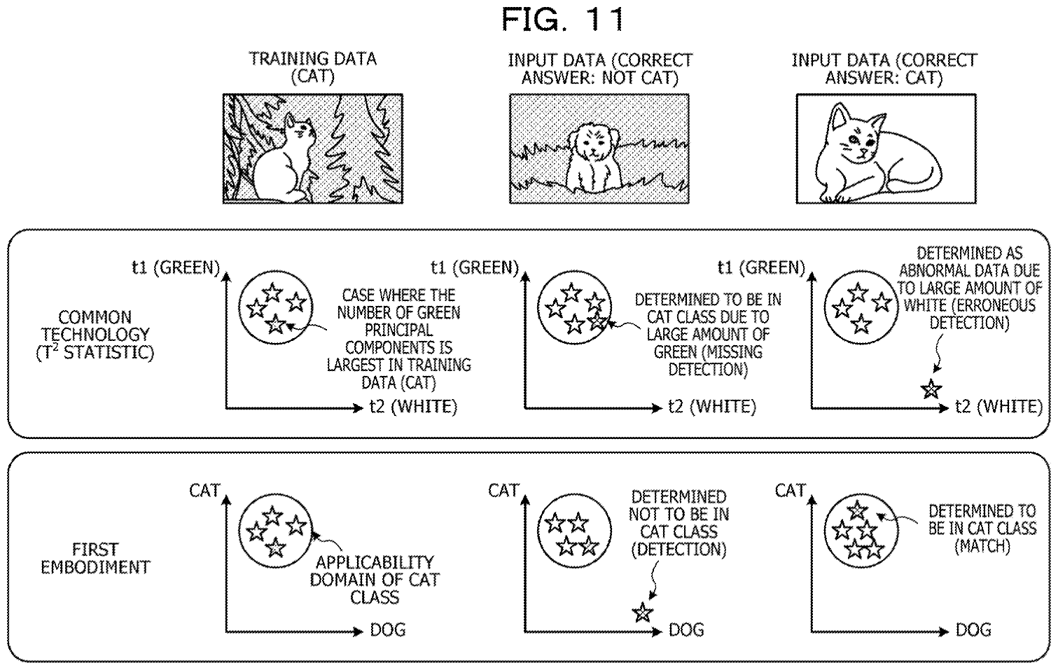

FIG. 11 is a diagram for describing a comparison result of detection of accuracy deterioration of high-dimensional data. In FIG. 11, the machine learning model 15 is trained by using image data of a cat in which green color is often used as a background as training data, and detection of accuracy deterioration by a common technology such as a T² statistic is compared with detection of accuracy deterioration by the method according to the first embodiment (using the inspector model). Note that a horizontal axis and a vertical axis of each graph in FIG. 11 also indicate feature amounts.

As illustrated in FIG. 11, the machine learning model 15 learns, as a feature amount, that the training data has a large number of green components and white components. Thus, in the common technology described above in which principal component analysis is performed, even in a case where image data of a dog having a large number of green components is input, the image data is determined to be in a cat class. Moreover, in the case of image data having an abnormally large amount of white, even when it is an image of a cat, it is not possible to detect that the image data is in the cat class because the feature amount of white is too large.

On the other hand, the inspector model according to the first embodiment has a narrower model applicability domain than that of the machine learning model 15. Thus, even in a case where image data of a dog having a large number of green components is input, the inspector model may determine that the image data is not in the cat class, and moreover, even in the case of image data of a cat having an abnormally large amount of white, a feature amount of a cat may be accurately learned, so that the inspector model may detect that the image data is in the cat class.

In this way, the inspector model of the accuracy deterioration detection apparatus 10 may detect input data having a feature amount different from that of learning data with high accuracy as compared with the common technology. Therefore, the accuracy deterioration detection apparatus 10 may follow distribution change of input data by a matching rate between the machine learning model 15 and the inspector model, and may detect accuracy deterioration of the machine learning model 15.

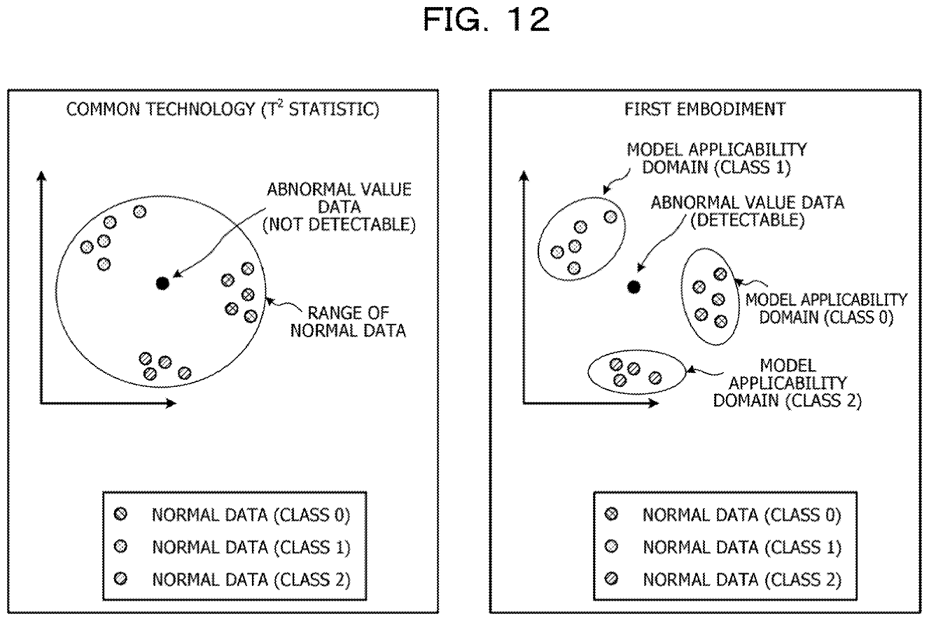

FIG. 12 is a diagram for describing a comparison result of detection of accuracy deterioration of multi-class classification. In FIG. 12, as in FIG. 11, detection of accuracy deterioration by the common technology such as the T² statistic is compared with detection of accuracy deterioration by the method according to the first embodiment (using the inspector model).

In the common technology illustrated in FIG. 12, since a distance of a principal component to a training data group is used for measurement, when data groups in multiple classes are mixed in training data, a range to be determined as normal data becomes wide, and it is not possible to detect abnormal data. For example, when a range of normal data for each of the class 0, the class 1, and the class 2 is decided, most of data belong to that ranges, and it is difficult to determine abnormal value data that should not belong to any of the ranges as abnormal. Thus, since it is not possible to detect that input data has changed to abnormal value data illustrated in FIG. 12, it is not possible to implement detection of accuracy deterioration of the model.

On the other hand, the inspector model according to the first embodiment has a narrower model applicability domain than that of the machine learning model 15. Thus, it is possible to distinguish between the model applicability domain of the class 0, the model applicability domain of the class 1, and the model applicability domain of the class 2. Thus, data belonging to other than the model applicability domains may be accurately detected as abnormal. Therefore, since it is possible to detect that input data has changed to abnormal value data illustrated in FIG. 12, it is possible to implement detection of accuracy deterioration of the model.

### SPECIFIC EXAMPLES

Next, a specific example of detecting accuracy deterioration by the inspector model by using an image classifier as the machine learning model 15 will be described. The image classifier is a machine learning model that classifies input images by class (category). For example, in a mail order sales site for apparel, an auction site for buying and selling clothing between individuals, or the like, an image of clothing is uploaded to the site and a category of the clothing is registered on the site. In order to automatically register the category of the image uploaded to the site, the machine learning model is used to predict the category of the clothing from the image. When a trend (data distribution) of the image of the clothing to be uploaded changes during the system operation, accuracy of the machine learning model deteriorates. In the common technology, correctness of a prediction result is manually confirmed, a correct answer rate is calculated, and accuracy deterioration of the model is detected. Thus, by applying the method according to the first embodiment, accuracy deterioration of the model is detected without using correctness information of the prediction result.

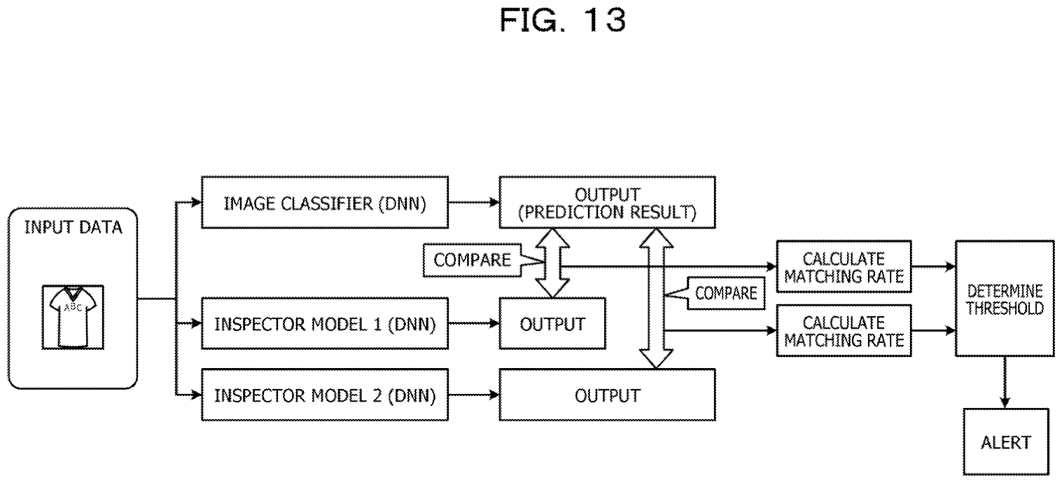

FIG. 13 is a diagram for describing a specific example using the image classifier. As illustrated in FIG. 13, the system illustrated in the specific example is a system that inputs input data to each of the image classifier, the inspector model 1, and the inspector model 2, detects accuracy deterioration of the image classifier by using a matching rate of a data distribution in a model applicability domain between the image classifier and each inspector model, and outputs an alert.

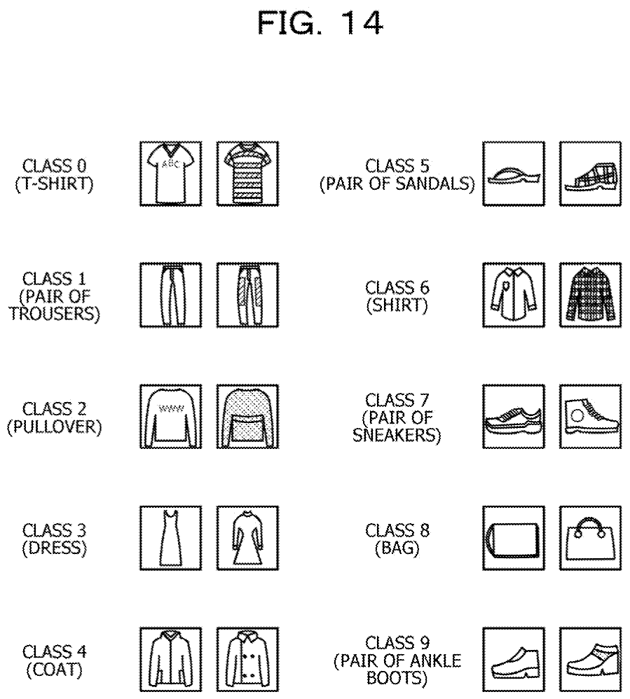

Next, teacher data will be described. FIG. 14 is a diagram for describing a specific example of the teacher data. As illustrated in FIG. 14, the teacher data of the specific example illustrated in FIG. 13 uses image data of each of a T-shirt with a label of the class 0, a pair of trousers with a label of the class 1, a pullover with a label of the class 2, a dress with a label of the class 3, and a coat with a label of the class 4. Furthermore, image data of each of a pair of sandals with a label of the class 5, a shirt with a label of the class 6, a pair of sneakers with a label of the class 7, a bag with a label of the class 8, and a pair of ankle boots with a label of the class 9 are used.

Here, the image classifier is a classifier using a DNN that performs 10-class classification, and is trained by 1000 pieces of teacher data/class and 100 epochs of the number of times of training. Furthermore, the inspector model 1 is a detector using a DNN that performs 10-class classification, and is trained by 200 pieces of teacher data/class and 100 epochs of the number of times of training. The inspector model 2 is a detector using a DNN that performs 10-class classification, and is trained by 100 pieces of teacher data/class and 100 epochs of the number of times of training.

For example, the model applicability domain is narrowed in the order of the image classifier, the inspector model 1, and the inspector model 2. Note that the teacher data has been selected at random from teacher data of the image classifier. Furthermore, a threshold of a matching rate of each class is 0.7 for both the inspector model 1 and the inspector model 2.

In such a state, the input data of the system illustrated in FIG. 13 uses an image (grayscale) of clothing (any of 10 classes) as well as the teacher data. Note that an input image may be a color image. The Input data matched to the image classifier (machine learning model 15) to be monitored is used.

In such a state, the accuracy deterioration detection apparatus 10 inputs the data input to the image classifier to be monitored to each inspector model, executes comparison of outputs, and accumulates comparison results (matching or non-matching) for each output class of the image classifier. Then, the accuracy deterioration detection apparatus 10 calculates a matching rate of each class from the accumulated comparison results (for example, the latest 100 pieces/class), and determines whether the matching rate is less than the threshold. Then, in a case where the matching rate is less than the threshold, the accuracy deterioration detection apparatus 10 outputs an alert for detection of accuracy deterioration.

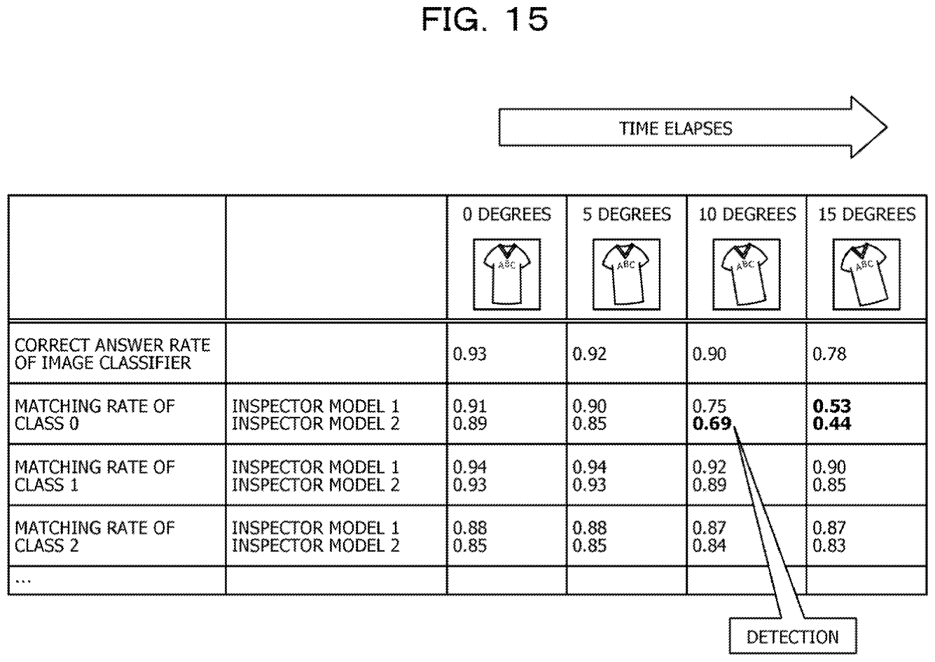

FIG. 15 is a diagram for describing an execution result of detection of accuracy deterioration. FIG. 15 illustrates an execution result in a case where the image is gradually rotated and the trend is changed only for the image of the class 0 (T-shirt) in the input data. When the data of the class 0 was rotated by 10 degrees, the matching rate of the inspector model 2 (0.69) fell below the threshold (for example, 0.7), and the accuracy deterioration detection apparatus 10 notified an alert. Note that, when the data of the class 0 was rotated by 15 degrees, the matching rate of not only the inspector model 2 but also the inspector model 1 decreased. For example, the accuracy deterioration detection apparatus 10 was able to detect accuracy deterioration of the model at the stage where a correct answer rate of the image classifier decreased slightly.

### Second Embodiment

Incidentally, in the first embodiment, an example has been described in which each inspector model in which the model applicability domain is reduced is generated by reduction of the training data, which is the opposite of data expansion which is a method of increasing the training data in order to expand the model applicability domain. However, even when the number of pieces of training data is reduced, the model applicability domain may not always be narrowed.

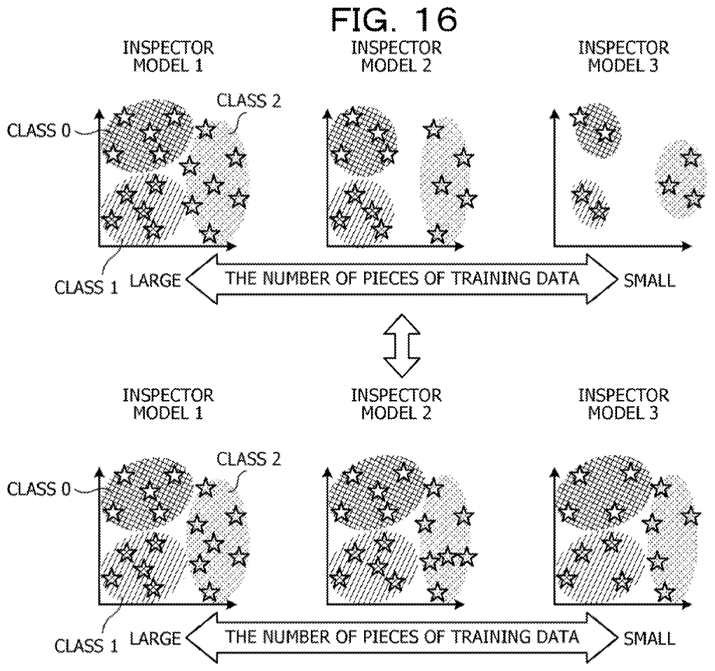

FIG. 16 is a diagram for describing an example of controlling a model applicability domain. As illustrated in an upper figure of FIG. 16, in the first embodiment, the training data of the inspector model is reduced at random, and the number of pieces of training data to be reduced is changed for each inspector model to generate the plurality of inspector models in which the model applicability domains are reduced. However, since it is unknown how narrow the model applicability domain becomes by reducing which pieces of training data, it is not always successful to intentionally adjust the model applicability domain to an optional size. Thus, as illustrated in a lower figure of FIG. 16, there is a case where the model applicability domain of the inspector model generated by reducing the training data is not narrowed. In this way, in a case where the model applicability domain is not narrowed, man-hours for remaking are needed.

Thus, in a second embodiment, a model applicability domain is surely narrowed by over-training by using the same training data as that of a machine learning model to be monitored. At this time, the size of the model applicability domain is optionally adjusted by a value of validation accuracy (correct answer rate for verification data).

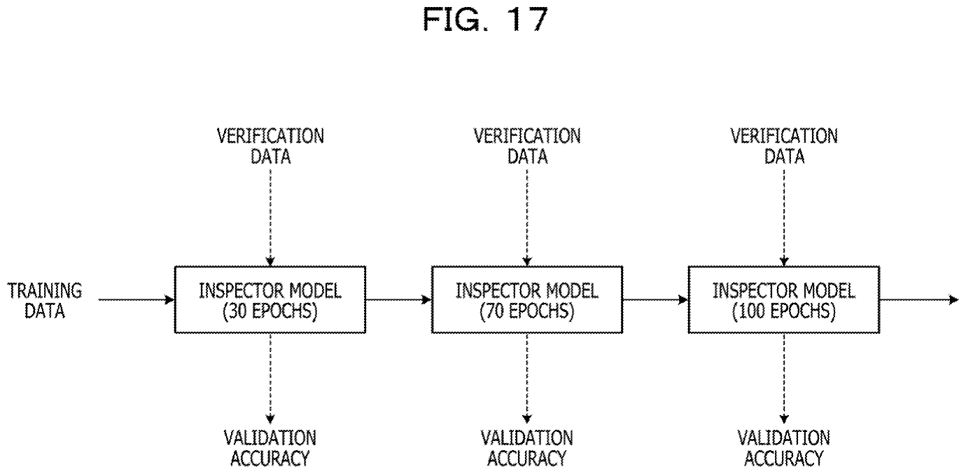

FIG. 17 is a diagram for describing an example of generating an inspector model according to the second embodiment. As illustrated in FIG. 17, in the second embodiment, at the timing when training of an inspector model is executed by 30 epochs by using training data, validation accuracy at that time is calculated and held by using verification data. Moreover, at the timing when training of the inspector model is executed by 70 epochs by using the training data, validation accuracy at that time is calculated and held by using the verification data, and at the timing when training of the inspector model is executed by 100 epochs, validation accuracy at that time is calculated and held. Then, a state of the inspector model (for example, a feature amount of a DNN) at each validation accuracy is held.

In this way, by monitoring, in the process of executing training by the training data, validation accuracy of the inspector model during training, and by intentionally over-training until the validation accuracy drops to an optional value, a state where generalization performance deteriorates due to the over-training occurs. For example, by holding a state of the inspector model with an optional value of the validation accuracy, an inspector model in which the size of a model applicability domain is optionally adjusted is generated.

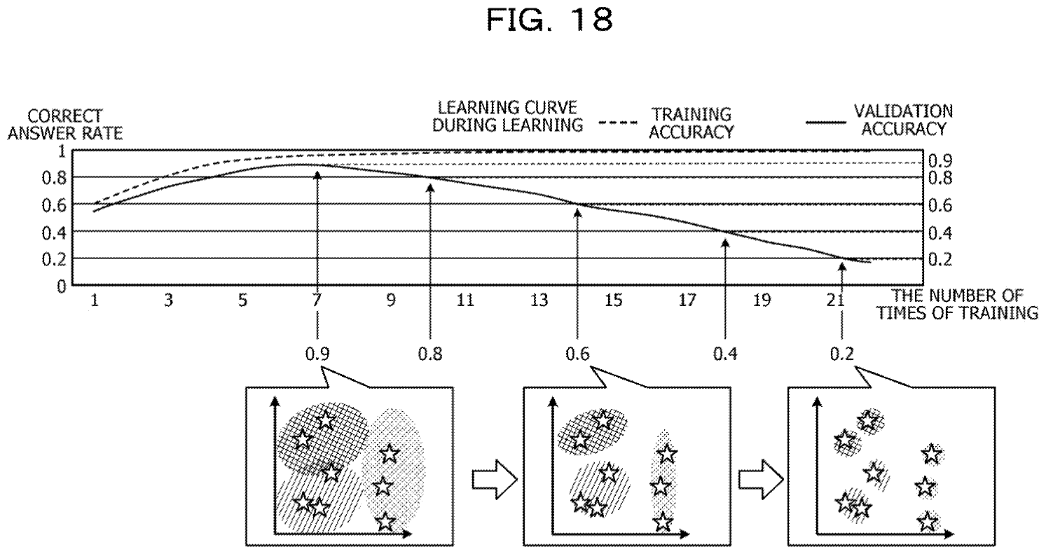

FIG. 18 is a diagram for describing change in validation accuracy. FIG. 18 illustrates a relationship between the number of times of training and a learning curve during learning. An inspector model generation unit 21 of an accuracy deterioration detection apparatus 10 according to the second embodiment surely narrows the model applicability domain by over-training by using the same training data as that of the machine learning model to be monitored. Commonly, the more a DNN used in an inspector model is over-trained, the more it is optimized to training data and the smaller a model applicability domain becomes.

As illustrated in FIG. 18, until a correct answer rate reaches 0.9, the correct answer rate gradually increases as the number of times of training increases. However, when the number of times of training is further increased from the number of times of training with which the correct answer rate reaches 0.9, training accuracy (correct answer rate for the training data) gradually increases, but validation accuracy decreases because of progress of over-training. For example, the more over-training is performed, the narrower the model applicability domain becomes, and the correct answer rate decreases with small change in input data. This is because the generalization performance is lost due to the over-training, and the correct answer rate for data other than the training data decreases. Since it may be confirmed that the model applicability domain is narrowed by this decrease in the value of the validation accuracy, it is possible to generate a plurality of inspector models having different model applicability domains by monitoring the value of the validation accuracy.

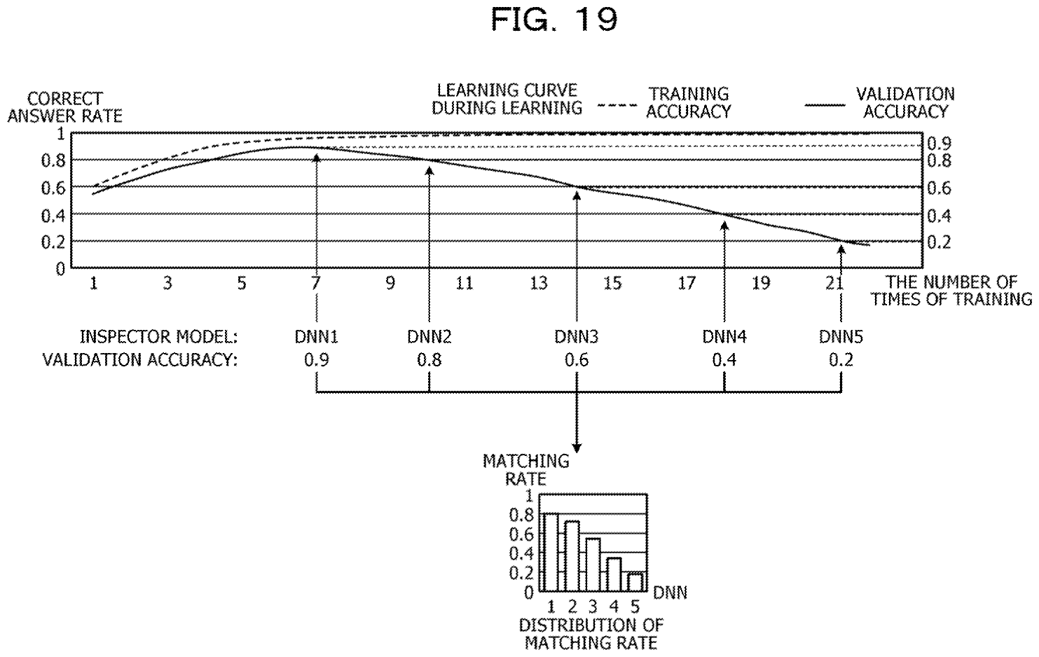

FIG. 19 is a diagram for describing generation of the inspector model by using the validation accuracy. FIG. 19 illustrates a relationship between the number of times of training and a learning curve during learning. As described above, the size of the model applicability domain of the inspector model may be measured on the basis of the height of the value of the validation accuracy. By creating a plurality of inspector models with different values of the validation accuracy, it is possible to ensure that the model applicability domains of the respective inspector models are different.

As illustrated in FIG. 19, the inspector model generation unit 21 trains inspector models (DNNs) by using training data, and acquires and holds various parameters of a DNN 1 when the value of the validation accuracy reaches 0.9. The inspector model generation unit 21 continues further training, and acquires and holds various parameters of a DNN 2 when the value of the validation accuracy reaches 0.8, various parameters of a DNN 3 when the value of the validation accuracy reaches 0.6, various parameters of a DNN 4 when the value of the validation accuracy reaches 0.4, and various parameters of a DNN 5 when the value of the validation accuracy reaches 0.2.

As a result, the inspector model generation unit 21 may generate the DNN 1, the DNN 2, the DNN 3, the DNN 4, and the DNN 5 whose model applicability domains are surely different. In a case where input data has the same distribution as that of the training data, “matching rate≈(validation accuracy)×correct answer rate of a model to be monitored”. For example, a distribution of a matching rate has a shape proportional to the validation accuracy of the inspector model, as illustrated in a graph in a lower figure of FIG. 19.

Since the accuracy deterioration detection apparatus 10 according to the second embodiment may always narrow the model applicability domain of the inspector model, it is possible to reduce man-hours for remaking the inspector model, which is needed in a case where the model applicability domain is not narrowed, or the like. Furthermore, since the accuracy deterioration detection apparatus 10 may measure the size of the model applicability domain on the basis of the height of the value of the validation accuracy, it is possible to always create the inspector models having the different model applicability domains by changing the value of the validation accuracy. Thus, a requirement “a plurality of inspector models having different model applicability domains” needed for detection of accuracy deterioration of the model may be always satisfied.

Furthermore, by detecting accuracy deterioration of the machine learning model 15 by using the plurality of inspector models generated by the method described above, the accuracy deterioration detection apparatus 10 according to the second embodiment may implement detection with higher accuracy than that of the first embodiment.

### Third Embodiment

Incidentally, in the second embodiment, an example has been described in which the model applicability domain is narrowed by over-training. However, even when the model applicability domain becomes narrow, there is a possibility that an event in which the position of the decision boundary of each class does not change, and change in the trend of the input data may not be detected may occur.

For example, in the case of training data in which features of each class are clearly separated, a position of a decision boundary of each class may not change even when the number of pieces of training data is reduced and training is performed. In a case where the position of the decision boundary does not change, which is, in the case of a state where an output of an inspector model is exactly the same as an output of a machine learning model to be monitored even outside a model applicability domain and all the outputs match, change in a trend of input data may not be detected.

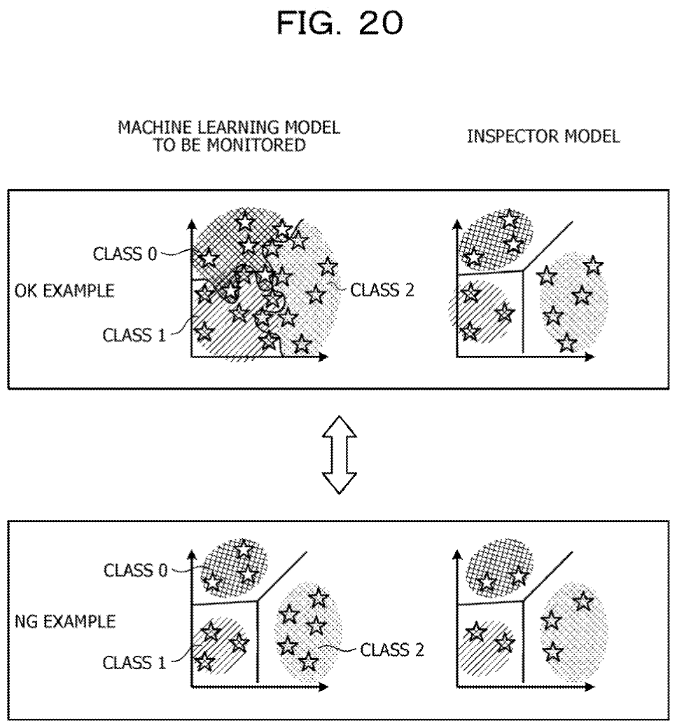

FIG. 20 is a diagram for describing an example in which boundary positions of the machine learning model and the inspector model do not change. In the case of an OK example in FIG. 20, when the number of pieces of training data is reduced and training is performed, the positions of the decision boundaries change, so that accuracy deterioration of the model may be detected by change in a matching rate. On the other hand, in the case of an NG example of FIG. 20, since the positions of the decision boundaries do not change, outputs of all pieces of the input data match, and it is not possible to detect accuracy deterioration of the model.

Thus, in the third embodiment, an “unknown class” is newly added to classification classes of the inspector model. Then, the inspector model is trained by using teacher data obtained by adding training data in the unknown class to the same training data set as that of the machine learning model to be monitored. The training data in the unknown class uses data unrelated to the original training data set. For example, data extracted at random from an unrelated data set having the same format, data automatically generated by setting a random value for each item, or the like is adopted. In a case where an output of the inspector model is in the unknown class, the input data is determined to be outside the model applicability domain.

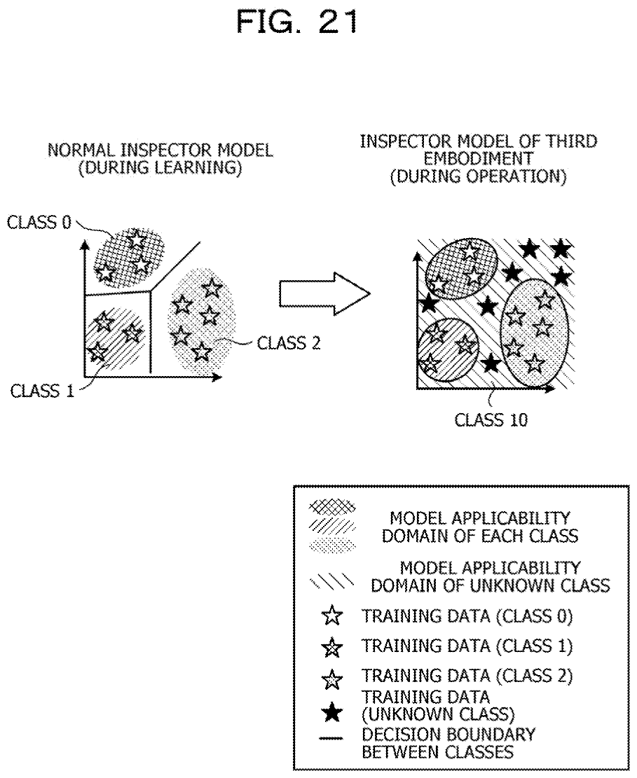

FIG. 21 is a diagram for describing the inspector model according to the third embodiment. As illustrated in FIG. 21, in the normal inspector model described in the first embodiment and the second embodiment, the feature amount space is classified into the model applicability domain of the class 0, the model applicability domain of the class 1, and the model applicability domain of the class 2. Thus, the normal inspector model may ensure a class to be classified for data corresponding to these model applicability domains, but may not ensure a class to be classified for data not corresponding to these model applicability domains. For example, when input data that should be classified as the class 0 is classified as the class 1 in the machine learning model 15 and is also classified as the class 1 in the inspector model, the classification results of the class 1 match and a matching rate does not decrease.

On the other hand, the inspector model of the third embodiment classifies a feature amount space into a model applicability domain of the class 0, a model applicability domain of the class 1, and a model applicability domain of the class 2, and classifies a domain that does not belong to any of the classes as a model applicability domain of a class 10 (unknown class). Thus, the inspector model of the third embodiment may ensure a class to be classified for data corresponding to the model applicability domain of each class, and may ensure that data not corresponding to the model applicability domain of each class is classified into the class 10.

As described above, the accuracy deterioration detection apparatus 10 according to the third embodiment newly adds, for each inspector model, the unknown class (for example, class 10) representing data outside the model applicability domain in addition to the output classes of the machine learning model 15 to be monitored. The accuracy deterioration detection apparatus 10 according to the third embodiment treats input data determined to be in the unknown class as “non-matching” in the mechanism of detection of accuracy deterioration of the model.

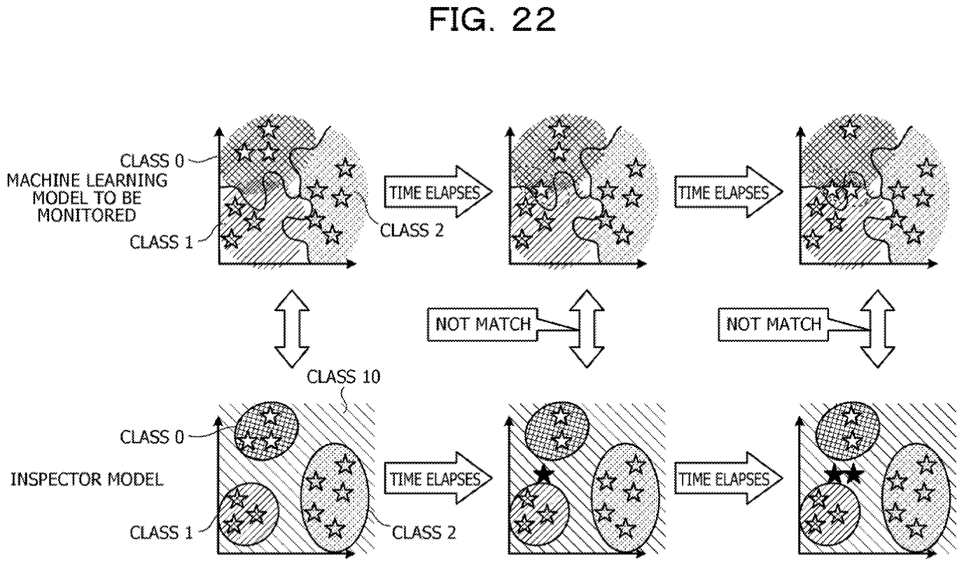

FIG. 22 is a diagram for describing detection of deterioration according to the third embodiment. As illustrated in FIG. 22, in a deterioration detection unit 23, at an initial stage of a start of operation, a matching rate remains high because each piece of input data belongs to a model application range of each class for each of the machine learning model 15 to be monitored and the inspector model.

Thereafter, as time elapses, a distribution of the input data begins to change. In this case, in the deterioration detection unit 23, each piece of input data belongs to the model application range of each class for the machine learning model 15 to be monitored, but input data classified into the class 10 (unknown class) appears for the inspector model. Here, the input data classified into the class 10 is in the class not classified in the machine learning model 15, and therefore matching does not occur. For example, the matching rate gradually decreases.

Thereafter, as time further elapses, the distribution of the input data begins to change further. In this case, in the deterioration detection unit 23, each piece of input data belongs to the model application range of each class for the machine learning model 15 to be monitored, but input data classified into the class 10 (unknown class) is frequently generated for the inspector model. Therefore, the deterioration detection unit 23 may detect that accuracy is deteriorated because the matching rate is below a threshold.

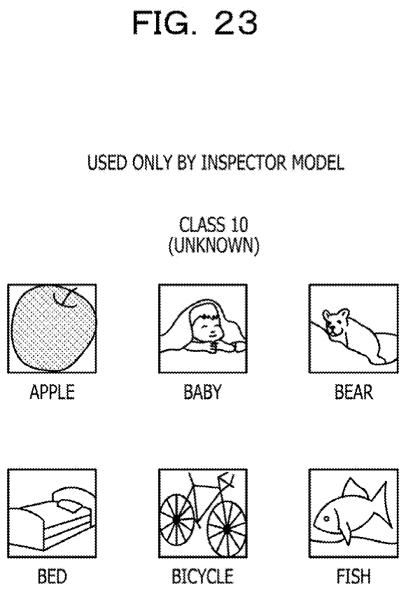

Here, an example of generating the inspector model according to the third embodiment will be described with reference to the specific example described with reference to FIG. 14. FIG. 23 is a diagram for describing an example of teacher data in the unknown class (class 10). As illustrated in FIG. 23, an inspector model generation unit 21 causes the inspector model to learn a model applicability domain of the class 10 by using, as teacher data, image data illustrated in FIG. 23 in addition to the image data described with reference to FIG. 14. For example, the inspector model generation unit 21 generates the inspector model by training by using second training data in which features different from those of first training data used in the machine learning model 15 are set at random, and which has a label indicating that data not learned in the machine learning model 15 is determined.

For example, as the teacher data for the class 10, 1000 images extracted at random from images in 1000 types of categories published on the Internet are used. For example, the inspector model is caused to learn the model applicability domain of the class 10 by using image data in a category different from that of the clothing illustrated in FIG. 14, which is, image data in which a label not included in the clothing is set, such as an image of an apple, an image of a baby, an image of a bear, an image of a bed, an image of a bicycle, or an image of a fish.

In the third embodiment, an image classifier is a classifier using a DNN that performs 10-class classification, and is trained by 1000 pieces of teacher data/class and 100 epochs of the number of times of training. Furthermore, the inspector model is a detector using a DNN that performs 11-class classification, and is trained by 1000 pieces of teacher data/class, 1000 unknown classes, and 100 epochs of the number of times of training. Note that the teacher data has been selected at random from teacher data of the image classifier.

In such a state, the accuracy deterioration detection apparatus 10 inputs the data input to the image classifier to be monitored to the inspector model, executes comparison of outputs, and accumulates comparison results (matching or non-matching) for each output class of the image classifier. Then, the accuracy deterioration detection apparatus 10 calculates a matching rate of each class from the accumulated comparison results (for example, the latest 100 pieces/class), and determines whether the matching rate is less than the threshold. Then, in a case where the matching rate is less than the threshold, the accuracy deterioration detection apparatus 10 outputs an alert for detection of accuracy deterioration.

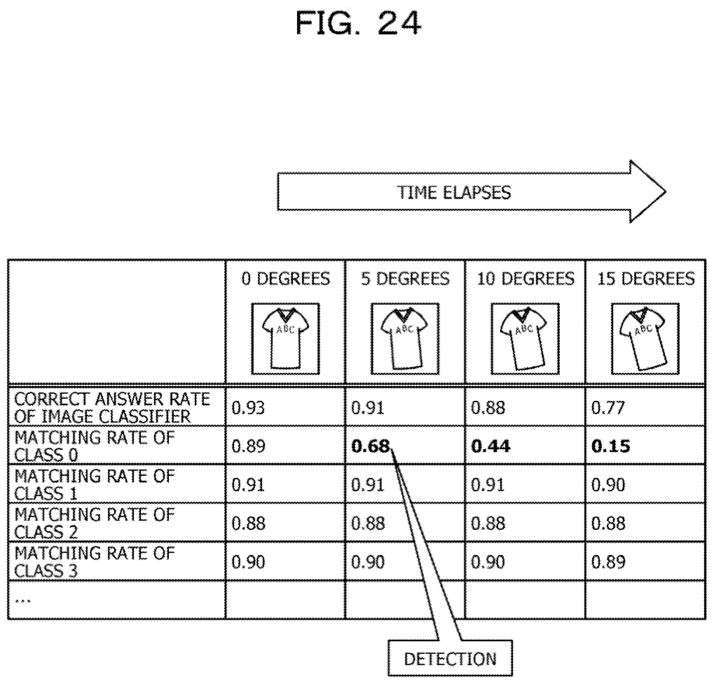

FIG. 24 is a diagram for describing an effect of the third embodiment. FIG. 24 illustrates an execution result in a case where the image is gradually rotated and the trend is changed only for the image of the class 0 (T-shirt) in the input data. When the data of the class 0 was rotated by 5 degrees, the matching rate of the inspector model (0.68) fell below the threshold (for example, 0.7), and the accuracy deterioration detection apparatus 10 notified an alert. For example, it was possible to detect accuracy deterioration of the model at the stage where a correct answer rate of the image classifier decreased slightly.

As described above, the accuracy deterioration detection apparatus 10 according to the third embodiment may generate the highly accurate inspector model capable of detecting accuracy deterioration even in the case of the training data in which features of each class are clearly separated, which is, even in a case where the decision boundary does not change. Furthermore, the accuracy deterioration detection apparatus 10 according to the third embodiment may sharply detect the distribution change in the input data by using the inspector model capable of detecting the unknown class. Note that the accuracy deterioration detection apparatus 10 according to the third embodiment may also detect accuracy deterioration on the basis of the matching rate of each class, and may also detect accuracy deterioration in a case where the number of appearances of the unknown classes exceeds the threshold.

### Fourth Embodiment

Incidentally, although the embodiments have been described above, the embodiments may be implemented in a variety of different forms in addition to the embodiments described above.

[Numerical Values or the Like]

Furthermore, the data examples, the numerical values, each threshold, the feature amount spaces, the number of labels, the number of inspector models, the specific examples, and the like used in the embodiments described above are merely examples and may be optionally changed. Furthermore, the input data, the training method, and the like are also merely examples and may be optionally changed. Furthermore, various methods such as neural networks may be adopted for the learning model.

[Model Application Range or the Like]

In the first embodiment, an example has been described in which a plurality of inspector models having different model application ranges by reducing the number of pieces of teacher data, but the embodiments are not limited to this. For example, it is also possible to generate a plurality of inspector models having different model application ranges by reducing the number of times of training (the number of epochs). Furthermore, it is also possible to generate a plurality of inspector models having different model application ranges by reducing the number of pieces of training data included in teacher data rather than the number of pieces of teacher data.

[Matching Rate]

For example, in the embodiments described above, an example has been described in which a matching rate of input data belonging to a model applicability domain of each class is obtained, but the embodiments are not limited to this. For example, accuracy deterioration may be detected by a matching rate between an output result of the machine learning model 15 and an output result of the inspector model.

Furthermore, in the example of FIG. 8, the matching rate is calculated by focusing on the class 0, but each class may also be focused on. For example, in the example of FIG. 8, after the time has elapsed, the monitoring unit 25 acquires from the machine learning model 15 to be monitored that six pieces of input data belong to the model applicability domain of the class 0, six pieces of input data belong to the model applicability domain of the class 1, and eight pieces of input data belong to the model applicability domain of the class 2. On the other hand, the monitoring unit 25 acquires from the inspector model that three pieces of input data belong to the model applicability domain of the class 0, nine pieces of input data belong to the model applicability domain of the class 1, and eight pieces of input data belong to the model applicability domain of the class 2. In this case, the monitoring unit 25 may detect a decrease in the matching rate for each of the class 0 and the class 1.

[Unknown Class]

In the third embodiment, a specific example has been described in which image data extracted at random from a data set unrelated to the original training data set but having the same format as the original training data set is used for training data in the unknown class, but the embodiments are not limited to this. For example, in the case of data such as a table, it is also possible to generate teacher data in the unknown class in which random values are set for each item.

[Retraining]

Furthermore, in a case where accuracy deterioration is detected, the accuracy deterioration detection apparatus 10 may retrain the machine learning model 15 by using a determination result of the inspector model as correct answer information. For example, the accuracy deterioration detection apparatus 10 may retrain the machine learning model 15 by generating retraining data using each piece of input data as an explanatory variable and a determination result of the inspector model for each piece of input data as an objective variable. Note that, in a case where there is a plurality of inspector models, an inspector model having a low matching rate with the machine learning model 15 may be adopted.

[System]

Pieces of information including a processing procedure, a control procedure, a specific name, various types of data, and parameters described above or illustrated in the drawings may be optionally changed unless otherwise specified.

Furthermore, each component of each device illustrated in the drawings is functionally conceptual and does not always have to be physically configured as illustrated in the drawings. For example, specific forms of distribution and integration of each device are not limited to those illustrated in the drawings. For example, the whole or a part thereof may be configured by being functionally or physically distributed or integrated in optional units according to various loads, usage situations, or the like. For example, a device that executes the machine learning model 15 to classify input data and a device that detects accuracy deterioration may be achieved in separate housings.

Moreover, all or an optional part of individual processing functions performed in each device may be implemented by a central processing unit (CPU) and a program analyzed and executed by the corresponding CPU or may be implemented as hardware by wired logic.

[Hardware]

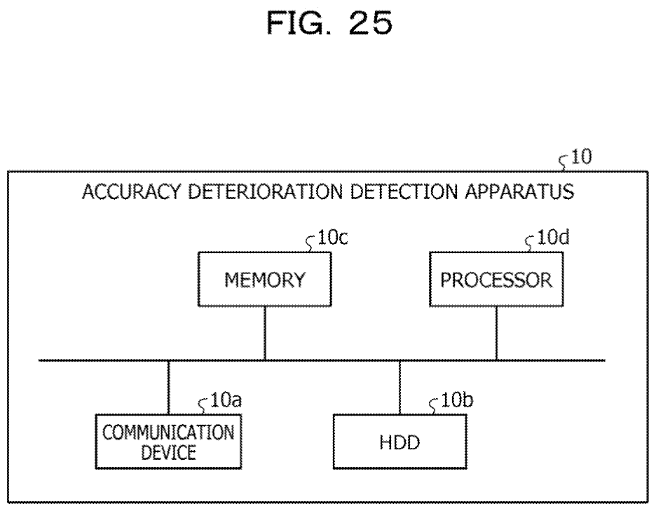

FIG. 25 is a diagram for describing a hardware configuration example. As illustrated in FIG. 25, the accuracy deterioration detection apparatus 10 includes a communication device 10a, a hard disk drive (HDD) 10b, a memory 10c, and a processor 10d. Furthermore, the respective units illustrated in FIG. 25 are interconnected by a bus or the like.

The communication device 10a is a network interface card or the like and communicates with another device. The HDD 10b stores a program that operates the functions illustrated in FIG. 4, and a DB.

The processor 10d reads a program that executes processing similar to the processing of each processing unit illustrated in FIG. 4 from the HDD 10b or the like, and develops the read program in the memory 10c, thereby operating a process that executes each function described with reference to FIG. 4 or the like. For example, this process executes functions similar to the functions of each processing unit included in the accuracy deterioration detection apparatus 10. For example, the processor 10d reads, from the HDD 10b or the like, a program having functions similar to the functions of the inspector model generation unit 21, the threshold setting unit 22, the deterioration detection unit 23, and the like. Then, the processor 10d executes a process for executing processing similar to the processing of the inspector model generation unit 21, the threshold setting unit 22, the deterioration detection unit 23, and the like.

In this way, the accuracy deterioration detection apparatus 10 operates as an information processing apparatus that executes an accuracy deterioration detection method by reading and executing the program. Furthermore, the accuracy deterioration detection apparatus 10 may also implement functions similar to the functions of the embodiments described above by reading the program described above from a recording medium by a medium reading device and executing the read program described above. Note that a program referred to in another embodiment is not limited to being executed by the accuracy deterioration detection apparatus 10. For example, the embodiments may be similarly applied also to a case where another computer or server executes the program, or a case where these computer and server cooperatively execute the program.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A computer-implemented generation method of generating a detection model, the generation method comprising:
acquiring training data that has been used in training of a trained model;
training the detection model on the basis of the acquired training data, the detection model being configured to detect accuracy deterioration occurred in the trained model by a change in a trend of data to be processed in a data stream;
determining, for the trained detection model, a state of over-training;
acquiring a feature amount of the trained detection model when the determined state of over-training satisfies a given condition; and
generating the detection model on the basis of the acquired feature amount.

2. The generation method according to claim 1, wherein
the acquiring of the training data includes acquiring the training data from among teacher data used for training of the trained model, and
the determining of the state of over-training includes determining the state of over-training on the basis of a correct answer rate when verification data in the teacher data is input to a detection model during training.

3. The generation method according to claim 2, wherein
the acquiring of the feature amount includes acquiring a first feature amount of the detection model when the correct answer rate reaches a first value is held, and a second feature amount of the detection model when the correct answer rate reaches a second value, and
the generating of the detection model includes generating a first detection model that uses the first feature amount, and a second detection model that uses the second feature amount.

4. A non-transitory computer readable recording medium storing a generation program of generating a detection model, the generation program comprising instructions which, when the generation program is executed by a computer, cause the computer to perform processing, the processing including:
acquiring training data that has been used in training of a trained model;
training the detection model on the basis of the acquired training data, the detection model being configured to detect accuracy deterioration occurred in the trained model by a change in a trend of data to be processed in a data stream;
determining, for the trained detection model, a state of over-training;
acquiring a feature amount of the trained detection model when the determined state of over-training satisfies a given condition; and
generating the detection model on the basis of the acquired feature amount.

5. An apparatus of generating a detection model, the apparatus comprising:
a memory; and
a processor coupled to the memory, the processor being configured to perform processing including:
acquiring training data that has been used in training of a trained model;
training the detection model on the basis of the acquired training data, the detection model being configured to detect accuracy deterioration occurred in the trained model by a change in a trend of data to be processed in a data stream;
determining, for the trained detection model, a state of over-training;
acquiring a feature amount of the trained detection model when the determined state of over-training satisfies a given condition; and
generating the detection model on the basis of the acquired feature amount.
